(19) United States
(12) Patent Application Publication
(10) Pub. No.: US 2018/0267132 A1
(43) Pub. Date: Sep. 20, 2018

(54) Method of Position and Motion Detection with Packet Communication

(71) Applicant: Quantek, Inc., Hsinchu City (TW)

(72) Inventors: Sheng Wang, Taipei City (TW); Yu-Liang Chen, Chiayi City (TW)

(21) Appl. No.: 15/687,549

(22) Filed: Aug. 28, 2017

Related U.S. Application Data
(60) Provisional application No. 62/472,559, filed on Mar. 16, 2017.

(51) Int. Cl. G01S 5/02

(52) U.S. Cl. CPC G01S 5/0252; H04B 17/318

(57) ABSTRACT

A method of position and motion detection with packet communication for a first radio node of a wireless communication system is disclosed. The method comprises periodically receiving at least a data packet from at least a second radio node of the wireless communication system, wherein the data packet includes an identity corresponding to the second radio node, measuring a RF power of the received data packet, establishing a detection table including the periodically measured RF powers and the corresponding identity of the received data packet, and determining an object is moving between the first radio node and the second radio node when detecting a RF power change between the currently measured RF power and the previously measured RF power according to the detection table.

### CROSS REFERENCE TO RELATED APPLICATIONS

This application claims the benefit of U.S. Provisional Application No. 62/472,559, filed on Mar. 16, 2017 and entitled “Object, Motion & Position detection by Digital packet wireless transmission network”, the contents of which are incorporated herein in their entirety.

### BACKGROUND OF THE INVENTION

### 1. Field of the Invention

The present disclosure relates to a method used in a wireless communication system, and more particularly, to a method of position and motion detection with packet communication.

### 2. Description of the Prior Art

A mesh network is a communications network made up of radio nodes organized in a mesh topology. Mesh network can be implemented with various wireless technologies including IEEE 802.11, 802.15, 802.16, cellular technologies, Bluetooth, Zigbee, Bluetooth Low Energy (BLE) and need not be restricted to any one technology or protocol. Recently, mesh network is applied for Internet of Things (IoT) device connection. This makes it much simpler to build a network of connected things and is, as a bonus, relatively inexpensive.

In addition, mesh network is commonly used for implementing positioning and motion detection. However, the applicant notices that there are several cons in conventional position and motion detection in the mesh network. Patent US 2015/0137971 in paras. [0038] and [0039] discloses that two nodes T2 and T3 calculate ellipses E2 and E3 with reflection signals caused by the object 34, and therefore the object 34 is located at intersections of the two ellipses E2 and E3. However, this position and motion detection method is inaccurate since the signals received by the nodes may not be a reflection signal from the object but interference.

In addition, Patent WO2006030422 in page 5, lines 19-22 discloses that “In order to obtain the first tag location, another distance from another element of the system, e.g. reader or tag, is measured to the first tag by measuring a round trip time delay including a time of flight of other wide-band signals communicating between the first tag and the other element” and in page 12, lines 19-22 discloses “Alternatively, reader 301 gets the response from tag 303b and measures a round trip delay (from Reader 301 to tag 303a to 303b and back to Reader 301; and similarly for 301 to 303c to 303b and back to Reader 301), and further makes use of the known location of tags 303a and 303c (and their internal delays) to establish the location of tag 303b”. In a word, Patent WO2006030422 discloses a position and motion detection method with signal round trip time delay to calculate distances between tags (including a tag with unknown location). Then, a location of the unknown location tag is estimated by using the known locations of the tags and the calculated distances. However, this method may cause redundant signal transmission/reception since the wide-band signals must be transmitted to the unknown location tag via the known location tags, so as to obtain a distance to the unknown location tag. Beside, this method is not efficient in time for motion detection.

### SUMMARY OF THE INVENTION

It is therefore an objective to provide a method of position and motion detection with packet communication to solve the above problems.

The present disclosure provides a method of position and motion detection with packet communication for a first radio node of a wireless communication system. The method comprises periodically receiving at least a data packet from at least a second radio node of the wireless communication system, wherein the data packet includes an identity corresponding to the second radio node, measuring a RF power of the received data packet, establishing a detection table including the periodically measured RF powers and the corresponding identity of the second radio node, and determining an object is moving between the first radio node and the second radio node when detecting a RF power change between the currently measured RF power and the previously measured RF power according to the detection table.

The present disclosure provides a communication device of a wireless communication system for position and motion detection with packet communication. The communication device comprises a storage unit for storing program code corresponding to a process, and a processing unit coupled to the storage unit, for processing the program code to execute the process, wherein the process comprises periodically receiving at least a data packet from at least a second radio node of the wireless communication system, wherein the data packet includes an identity corresponding to the second radio node, measuring a radio frequency (RF) power of the received data packet, establishing a detection table including the periodically measured RF powers and the corresponding identity of the received data packet, and determining an object is moving between the first radio node and the second radio node when detecting a RF power change between the currently measured RF power and the previously measured RF power according to the detection table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a packet transmission in a mesh network according to one embodiment of the present disclosure.

FIG. 2 is a schematic diagram of a communication device according to one embodiment of the present disclosure.

FIG. 3 is a flowchart of a process according to one embodiment of the present disclosure.

FIGS. 4A-4B are schematic diagrams of detection table establishment according to one embodiment of the present disclosure.

FIG. 5A-5B are schematic diagrams of position and motion detection system according to one embodiment of the present disclosure.

FIGS. 6A-6B are schematic diagrams of node deployment of a motion detection system according to one embodiment of the present disclosure.

FIGS. 7A-7C are schematic diagrams of a position and motion detection with reflection signal according to one embodiment of the present disclosure.

FIGS. 8A-8B are schematic diagrams of position and motion detection with dual reflection signal according to one embodiment of the present disclosure.

### DETAILED DESCRIPTION

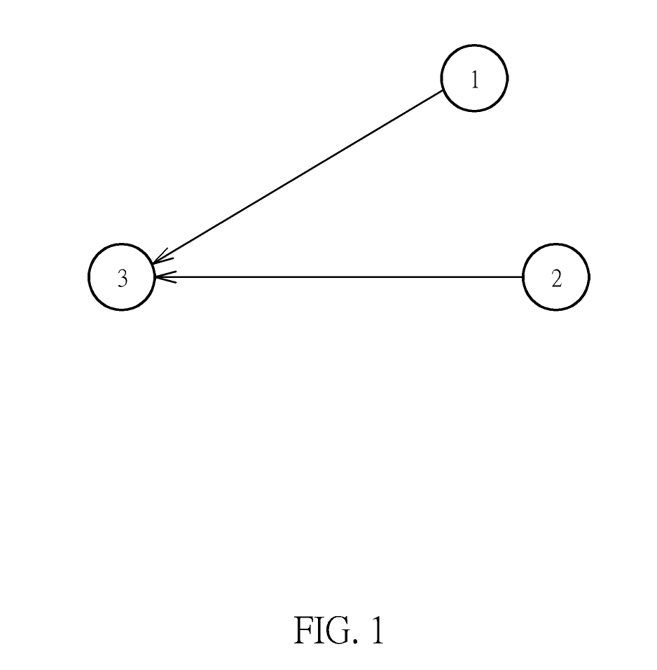

FIG. 1 is a schematic diagram of a packet transmission in a mesh network according to one embodiment of the present disclosure. The mesh network includes three radio nodes 1-3, but the number of radio nodes is not limited herein. Each node can communicate wirelessly with the other radio nodes that are in effective range of it. For example, the radio node 3 is in the effective range of radio nodes 1-2, and therefore receives data packets from the radio nodes 1-2. With the same manner, the radio node 1 can receive data packets from the radio nodes 2-3, and the radio node 2 can receive data packets from the radio nodes 1 and 3. It is noted that the radio nodes 1-3 transmit the data packets with their identities included in the data packets. In other words, the received data packet includes an identity of the sender, so that the receiver can know which node of the mesh network sent the data packet.

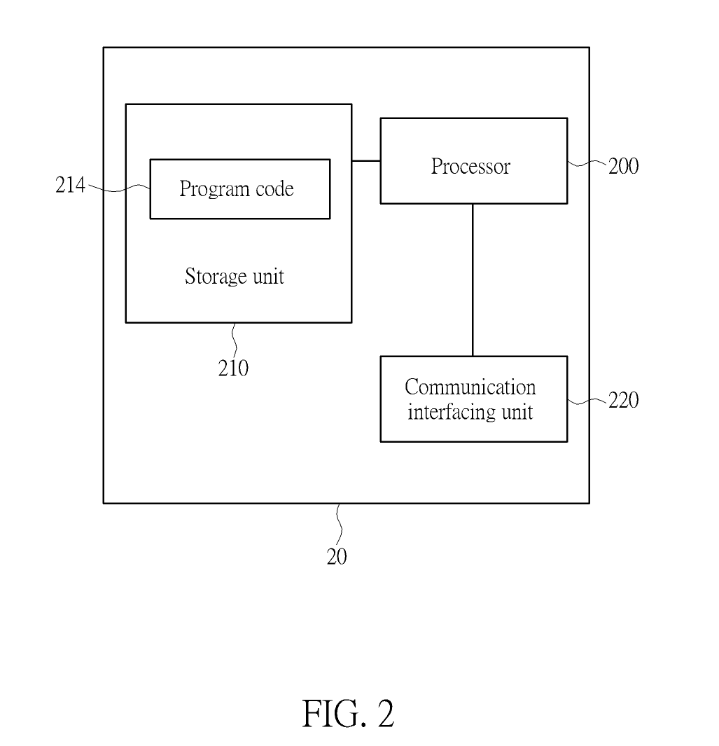

FIG. 2 is a schematic diagram of a communication device 20 according to one embodiment of the present disclosure. The communication device 20 includes a processor 200, such as a microprocessor or Application Specific Integrated Circuit (ASIC), a storage unit 210 and a communication interfacing unit 220. The storage unit 210 may be any data storage device that can store a program code 214, for access by the processor 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange wireless signals with another network device or mobile device according to processing results of the processor 200.

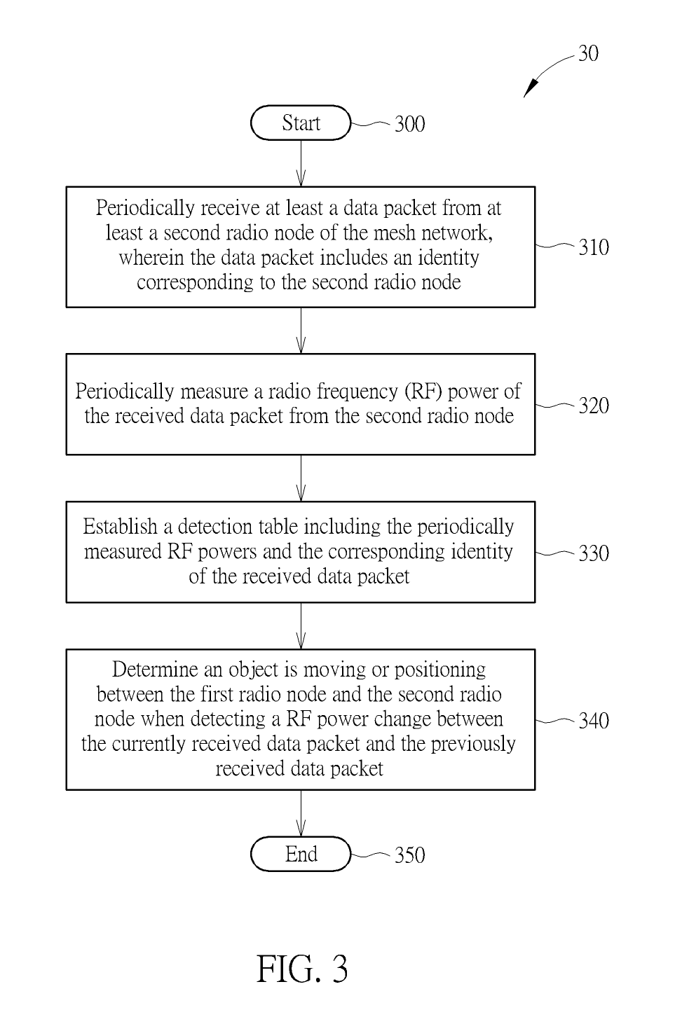

Reference is made to FIG. 3. A flowchart of a process 30 according to an embodiment of the present disclosure is illustrated. The process 30 could be utilized in the communication device 20 of FIG. 2 for position and motion detection in the mesh network. The communication device 20 can be any radio node of the mesh network of FIG. 1 (hereafter called as the first radio node. The process 30 may be compiled into a program code 214 to be stored in the storage unit 210, and may include the following steps:

Step 300: Start.

Step 310: Periodically receive at least a data packet from at least a second radio node of the mesh network, wherein the data packet includes an identity corresponding to the second radio node.

Step 320: Periodically measure a radio frequency (RF) power of the received data packet from the second radio node.

Step 330: Establish a detection table including the periodically measured RF powers and the corresponding identity of the received data packet.

Step 340: Determine an object is moving or positioning between the first radio node and the second radio node when detecting a RF power change between the currently measured RF power and the previously measured RF power according to the detection table.

Step 350: End.

According to the process 30, the first radio node records the measured RF power of the received data packet over time with the corresponding identity in the received data packet the second radio node, to establish the detection table. In other words, the detection table includes RF power values corresponding to the second radio node and varying with time. As a result, when the first radio node detects a RF power change according to the detection table, the first radio node knows that an object is moving or positioning between the first radio node and the second radio node.

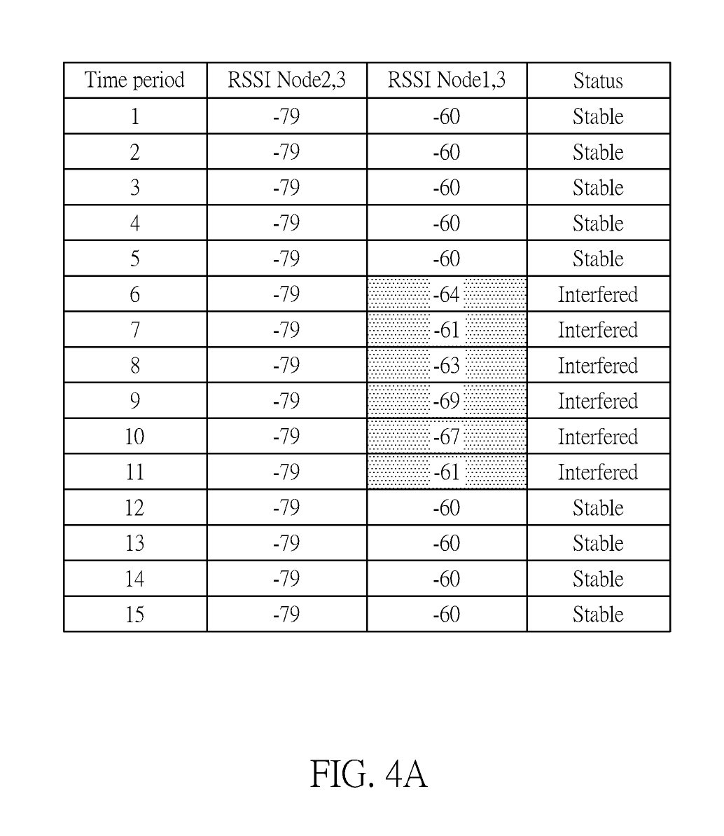

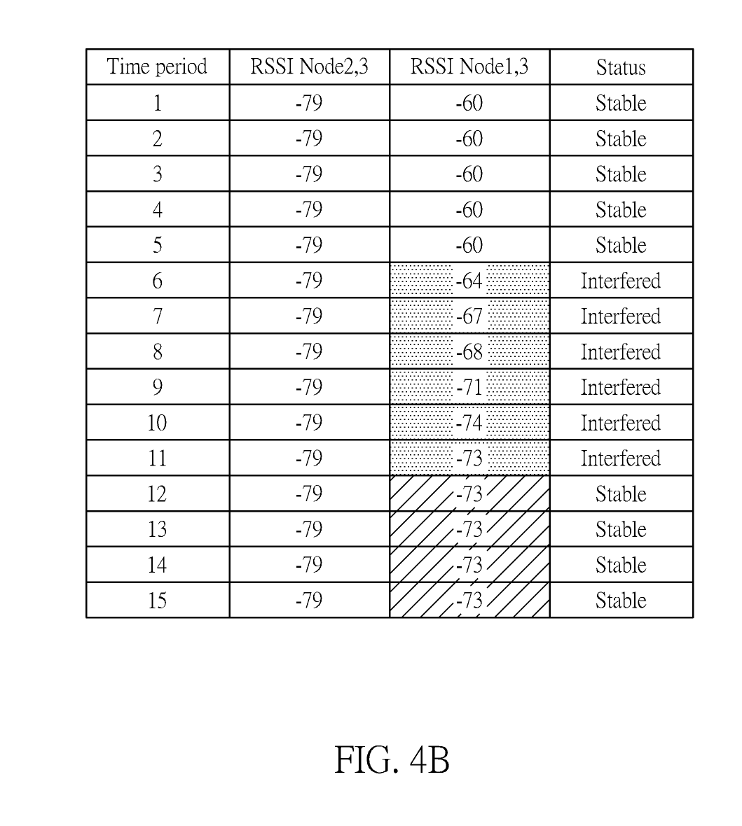

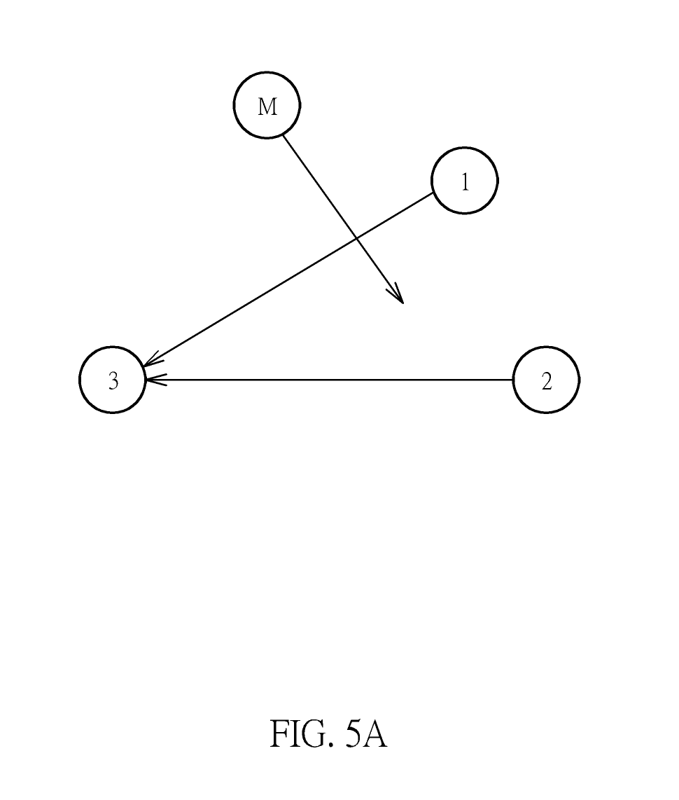

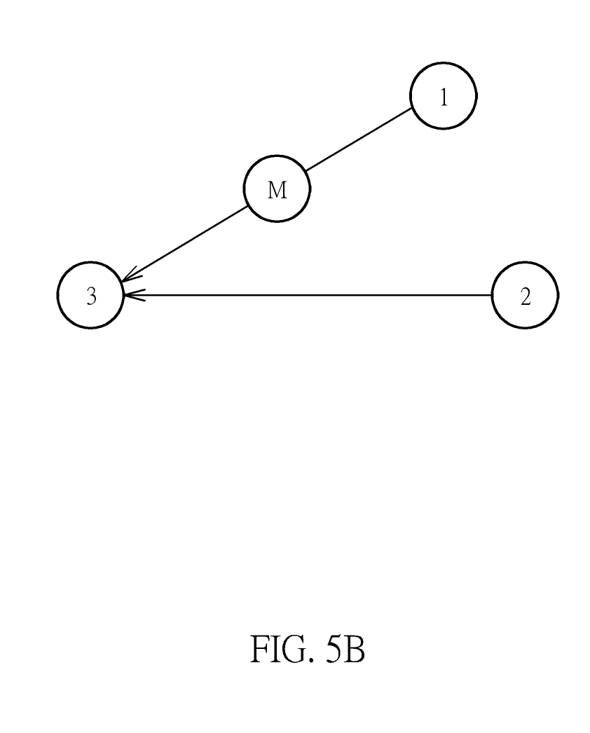

Reference is made to FIG. 4A-4B, which illustrate examples of detection table establishment according to embodiments of the present disclosure. Please also refer to FIG. 5A, as abovementioned, the radio nodes 1-2 periodically transmit data packets including their identities to the radio node 3. The radio node 3 measures the RF power of the data packets from the radio nodes 1-2, and records the RF powers corresponding to the radio nodes 1-2 over time, so as to establish the detection table shown in FIGS. 4A-4B. In FIG. 4A, the radio nodes 3 records received signal strength indicator (RSSI) values between the radio nodes 1 and 3 and between the radio nodes 2 and 3 with time periods “1”-“15”. If there is no moving object, the recorded RSSI values between the radio nodes 2 and 3 (marked as RSSI Node 2,3) and radio nodes 1 and 3 (marked as RSSI Node 1,3) are stable (i.e. RSSI Node 2,3=−79 dBm in time period “1”-“15” and RSSI Node 1,3=−60 dBm in time period “1”-“5”). However, if a moving object M interferes a wireless link on which the data packet is transmitted/received between the radio nodes 1 and 3, the recorded RSSI values between the radio nodes 1 and 3 becomes unstable (i.e. RSSI Node 1,3=−64 dBm, −61 dBm, −63 dBm, −69 dBm, −67 dBm, −61 dBm in the time periods “6”-“11”). On the other hand, after the moving object M leaves the wireless link, the RSSI value between the radio nodes 1 and 3 is therefore returned to stable and to the original RSSI value (i.e. RSSI Node 1,3=−60 dbm in the time periods “12”-“15”). In other embodiment, as shown in FIGS. 4B and 5B, if the object M stays or blocks at the wireless link, the RSSI value between the radio nodes 1 and 3 is returned to stable but to the new RSSI value (i.e. RSSI Node 1,3=−73 dbm).

Based on the abovementioned, RF power change is caused by object interference, and thus it can be used as a position and motion detector. Consequently, the wireless links between the radio nodes 1 and 3, and between the radio nodes 2 and 3 can be treated as a RF fence. It is noted that, although the radio node receives multiple data packets from other radio nodes, the radio node 3 knows the data packets are from which radio nodes according to the identities in the data packets. Thus, the radio node 3 can know which RF fence has been interfered or blocked no matter how many radio nodes in the mesh network.

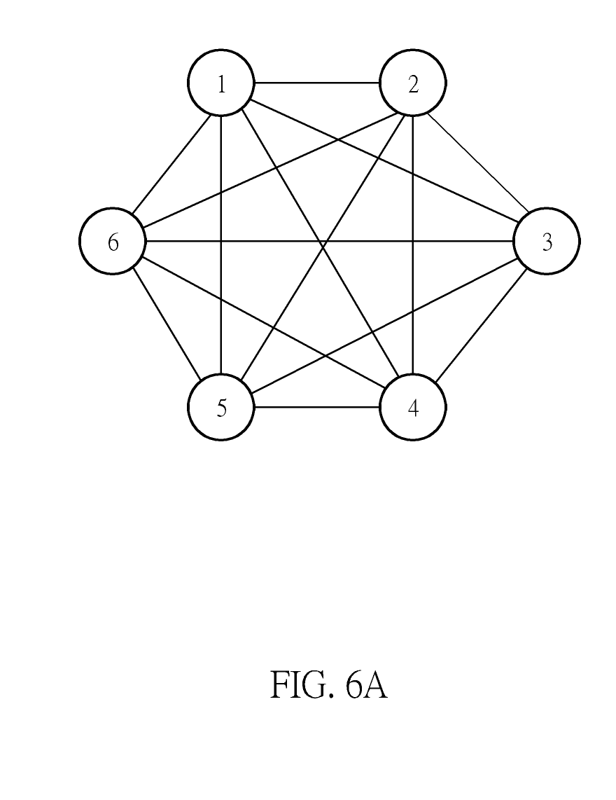

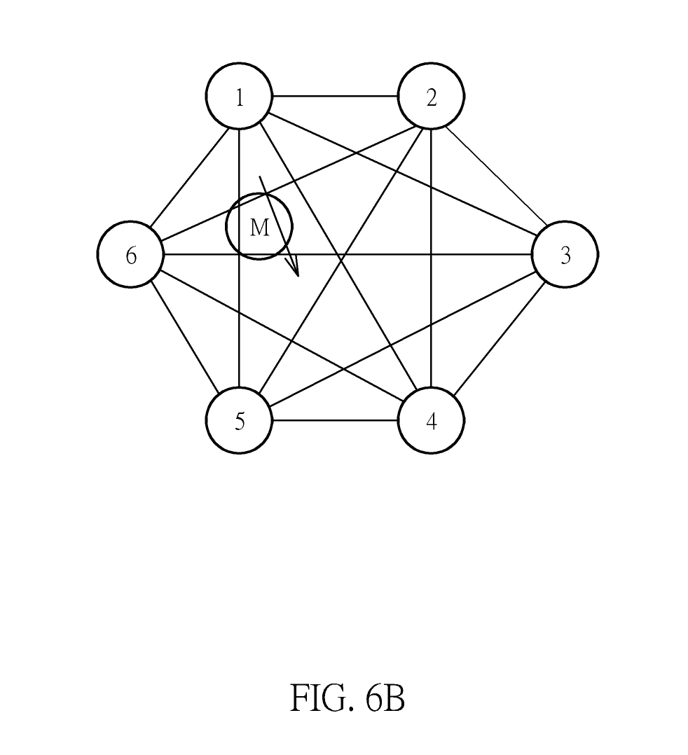

Please refer to FIG. 6A, which illustrates an example of a position and motion detection system according to one embodiment of the present disclosure. In FIG. 6A, the radio nodes 1-6 each periodically transmits data packets along with its own identity within its RF range. That is, the radio nodes 1-6 of the position and motion detection system creates 15 RF fences, each RF fence can be clearly identified by its source and destination radio nodes by the data packets, so that the RF fences can cover the whole area. Reference is made to FIG. 6B for a transparent operation of a position and motion detection system. In FIG. 6B, the RF Fences (1,5), (2,6) and (3,6) have been blocked by the object M. Since the radio nodes 1-6 continuously record the RF powers and corresponding identities of the received data packets, a position or moving direction of the object M can be estimated based on the RF power change. More specifically, with node identity, the moving direction can be observed by the interfered RF fence sequences. For example, the RF power change is occurred on RF fences (1,5), (2,6) and (3,6), and therefore the moving direction of the object M is predictable as indicated by the arrow shown in FIG. 6B. In addition, if the object M is blocked at a certain RF fence, the position of the object M can be estimated by RSSI value between the object M and the radio nodes of the certain RF fence. For example, when the RF power change is occurred on the RF fence (3,6), the position of the object M is calculated according to a RSSI values between the object M and radio nodes 3 and 6.

As can be seen, the more RF fence number is, the more accurate for position and motion detection is. It is noted that with node identity in the data packet, any two nodes of the position and motion detection system can create one RF fence since they can discriminate each other with the node identity. That is, with node number=N, the RF fence number=N*(N−1)/2 according to the combination equation for the number of possible combinations. For example, if the position and motion detection system includes 10 radio nodes, the RF fence number is increased to 45, which is almost in exponential order for precise position and motion detection.

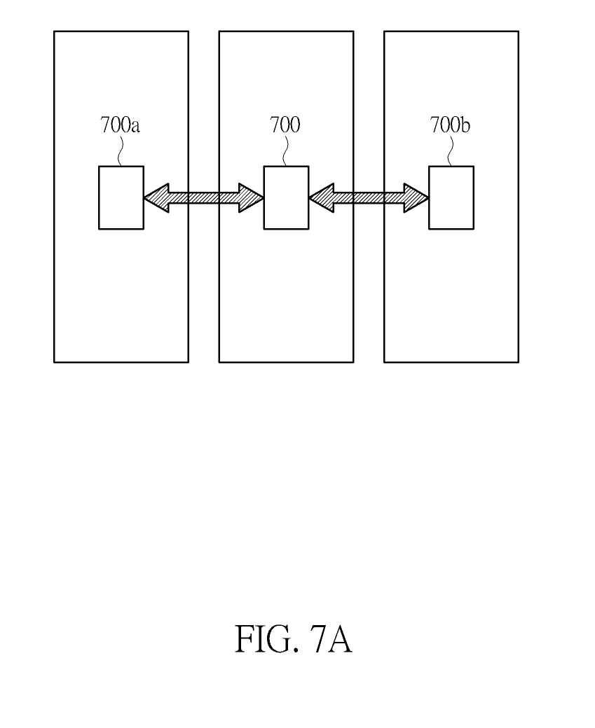

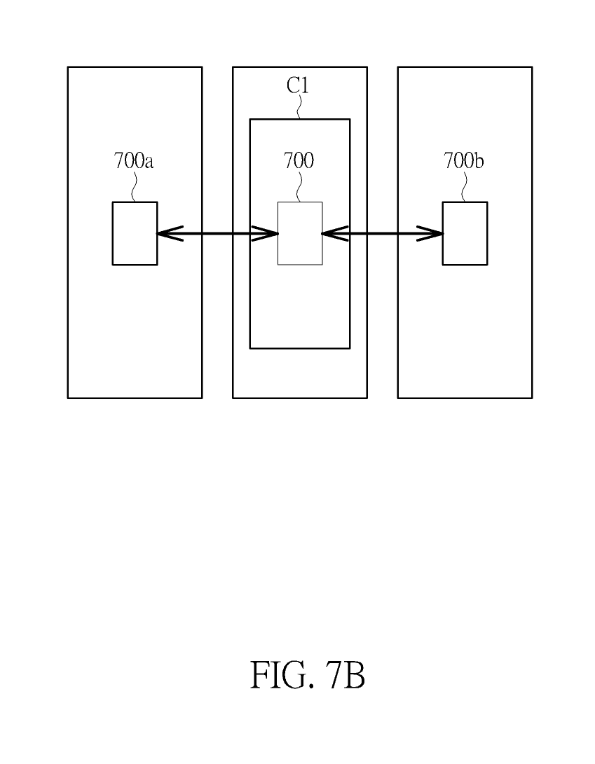

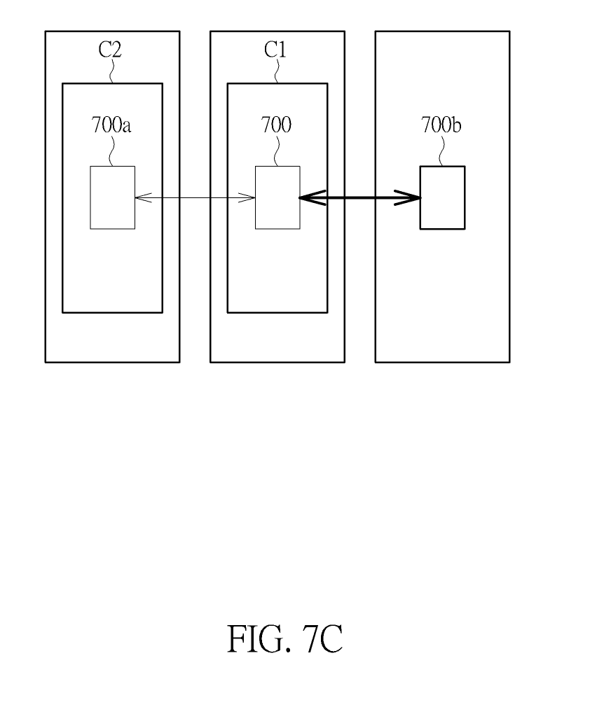

Moreover, the position and motion detection method of the present invention can be applied for parking lot status detection. Reference is made to FIGS. 7A-7C for a reflection operation of a position and motion detection system. With abovementioned concept, the RF node 700 can detect the RF signal power, RSSI, coming from its adjacent nodes 700a and 700b. The RF node 700 records the RSSI of the adjacent nodes with their identities to establish the parking lot status detection table including the recorded RSSI and corresponding identity. In FIG. 7A, if there is no car interfered, the center RF node 700 shall receive strong and stable RSSIs from adjacent nodes 700a and 700b. In FIG. 7B, if the center RF node 700 discovers that the recorded RSSI of the parking lot status detection table are not coincident, namely RSSI change (i.e. from strong RSSI to middle RSSI of FIG. 7B), the center RF node 700 knows that there is a car C1 parks on its place. Similarly, if the center RF node 700 discovers that the RSSI change is from middle RSSI to weak RSSI as shown in FIG. 7C, it means that there is another car parked on its adjacent place. It is noted that, instead of RSSI change detected by the center RF node 700, any RF node (i.e. adjacent nodes 700a and 700b) can perform abovementioned RSSI change detection, and then reports the RSSI change event to the center RF node 700 through the network (i.e. any wireless technology). As a result, the center RF node 700 can judge the car parking situation by the RSSI change.

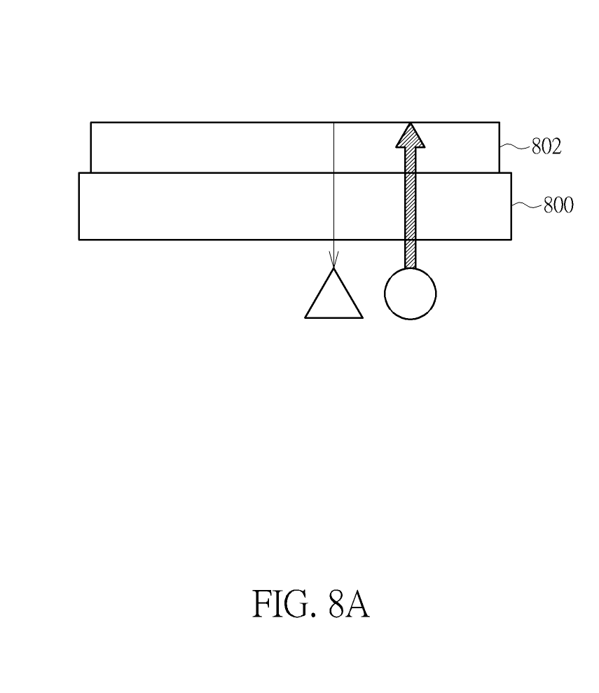

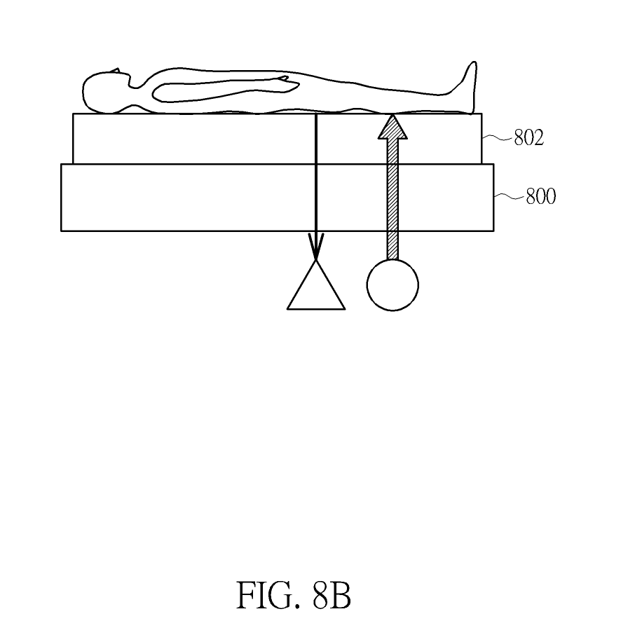

In addition, the position and motion detection method of the present invention can be applied for medical treatment. Reference is made to FIGS. 8A-8B for a dual reflection operation of a position and motion detection system. This idea is used in a position and motion detection system without metal object to absorb all the RF power. FIG. 8A shows a non-metal bed 800 with mattress 802 on it. The TX RF node transmits a RF signal toward the mattress 802, and then the RX RF node receives a weak RSSI of the reflection RF signal. However, if there is a person lies on the mattress 802, the RX RF node receives a strong RSSI of the reflection R RF signal. As a result, the RX RF node can know the status of the bed according to the RSSI change, which can be used for statistics of patient number.

With the abovementioned position and motion detection method, the data packet includes an identity for distinguishing the sender node, so as to define the RF fence of the position and motion detection system. In addition, it is easy to set up a huge number of the position and motion detection system, to over a full area for accurate position and motion detection. Moreover, since the received data packet is with the identity, the receiver node can recognize whether the received signal is interference, to avoid inaccurate position and motion estimation. Besides, the position and motion detection system can be a digital RF system, so that the network can be set to deactivation at the same time period, and then be activated in another time period. Thus, the power consumption of the radio nodes of the position and motion detection system is saved.

The abovementioned steps of the processes including suggested steps can be realized by means that could be a hardware, a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the communication device 20.

In conclusion, the present invention aims at establishing a position and motion detection table with received data packet including an identity of the sender node, so that the receiver node can immediately know which RF fence of the position and motion detection system is interfered by an object with observation of RF power change based on the position and motion detection table.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of position and motion detection with packet communication for a first radio node of a wireless communication system, the method comprising:
periodically receiving at least a data packet from at least a second radio node of the wireless communication system, wherein the data packet includes an identity corresponding to the second radio node;
measuring a radio frequency (RF) power of the received data packet;
establishing a detection table including the periodically measured RF powers and the corresponding identity of the received data packet; and
determining an object is moving between the first radio node and the second radio node when detecting a RF power change between the currently measured RF power and the previously measured RF power according to the detection table.

2. The method of claim 1, further comprising:
periodically transmitting a data packet to the second radio node, wherein the data packet includes an identity of the first radio node.

3. The method of claim 1, further comprising:
detecting multiple RF power changes between the first radio node and the second radio node and between the second radio nodes according to the detection table; and
determining a moving direction of the object according to the occurred sequence of the multiple RF power changes.

4. The method of claim 1, further comprising:
reporting the recorded RF power and identity to an adjacent radio node; or
reporting the RF power change event to the adjacent radio node.

5. The method of claim 1, wherein the measured RF power is a directly received RF signal or reflected received RF signal.

6. The method of claim 1, further comprising:
determining the object is positioning between the first radio node and the second radio node when the measured RF powers are coincident in a period of time.

7. The method of claim 1, further comprising:
establishing at least a radio link with the at least a second radio node according to the identity corresponding to the second radio node;
wherein a number of the radio link is calculated according to a combination equation: N*(N−1)/2, wherein N indicates a number of radio nodes of the wireless communication system.

8. A communication device of a wireless communication system for position and motion detection with packet communication, comprising:
a storage unit for storing program code corresponding to a process; and
a processing unit coupled to the storage unit, for processing the program code to execute the process;
wherein the process comprises:
periodically receiving at least a data packet from at least a second radio node of the wireless communication system, wherein the data packet includes an identity corresponding to the second radio node;
measuring a radio frequency (RF) power of the received data packet;
establishing a detection table including the periodically measured RF powers and the corresponding identity of the received data packet; and
determining an object is moving between the communication device and the second radio node when detecting a RF power change between the currently measured RF power and the previously measured RF power according to the detection table.

9. The communication device of claim 8, wherein the process further comprises:
periodically transmitting a data packet to the second radio node, wherein the data packet includes an identity of the communication device.

10. The communication device of claim 8, wherein the process further comprises:
detecting multiple RF power changes between the communication device and the second radio node and between the second radio nodes according to the detection table; and
determining a moving direction of the object according to the occurred sequence of the multiple RF power changes.

11. The communication device of claim 8, wherein the process further comprises:
reporting the recorded RF power and identity to an adjacent radio node; or
reporting the RF power change event to the adjacent radio node.

12. The communication device of claim 8, wherein the measured RF power is a directly received RF signal or reflected received RF signal.

13. The communication device of claim 8, wherein the process further comprises:
determining the object is positioning between the communication device and the second radio node when the measured RF powers are coincident in a period of time.

14. The communication device of claim 8, wherein the process further comprises:
establishing at least a radio link with the at least a second radio node according to the identity corresponding to the second radio node;
wherein a number of the radio link is calculated according to a combination equation: N*(N−1)/2, wherein N indicates a number of radio nodes of the wireless communication system.
